(19) United States
(12) Patent Application Publication
(10) Pub. No.: US 2025/0228234 A1
(43) Pub. Date: Jul. 17, 2025

(54) TREE SADDLE

(71) Applicant: Latitude Outdoors, LLC, Grand Rapids, MI (US)

(72) Inventors: Kevin Leach, Grand Rapids, MI (US); Alex Chopp, Royal Oak, MI (US); Jake Matelic, Royal Oak, MI (US)

(73) Assignee: Latitude Outdoors, LLC, Grand Rapids, MI (US)

(21) Appl. No.: 19/015,960

(22) Filed: Jan. 10, 2025

Related U.S. Application Data
(60) Provisional application No. 63/620,039, filed on Jan. 11, 2024.

(51) Int. Cl. A01M 31/02; A62B 35/00

(52) U.S. Cl. CPC A01M 31/02; A62B 35/0012

(57) ABSTRACT

A tree saddle includes a panel for cradling a user, a first connector portion that extends from the upper support portion to the lower support portion at the first lateral end of the panel to form a first loop, and a second connector portion that extends from the upper support portion to the lower support portion at the second lateral end of the panel to form a second loop. The panel extends from a first lateral end to a second lateral end opposite the first lateral end and includes an upper support portion, a lower support portion, and a central body portion that is coupled to and extends between the upper and lower support portions.

### CROSS-REFERENCE TO RELATED APPLICATIONS

This application claims priority to and the benefit under 35 U.S.C. § 119(e) of U.S. Provisional Patent Application No. 63/620,039, filed Jan. 11, 2024, entitled TREE SADDLE, the entire disclosure of which is hereby incorporated herein by reference.

### FIELD OF THE DISCLOSURE

The present concept generally relates to a tree saddle and, more particularly, a tree saddle with a cradling panel formed of upper and lower support portions and a central body portion with particular sizes relative to each other.

### BACKGROUND OF THE DISCLOSURE

Tree saddles are often used for work or recreational activities, such as tree saddle hunting.

### SUMMARY OF THE DISCLOSURE

According to a first aspect of the disclosure, a tree saddle includes a panel for cradling a user. The panel extends from a first lateral end to a second lateral end opposite the first lateral end. The panel includes an upper support portion, a lower support portion, and a central body portion that is coupled to and extends between the upper and lower support portions. A first connector portion extends from the upper support portion to the lower support portion at the first lateral end of the panel to form a first loop. A second connector portion extends from the upper support portion to the lower support portion at the second lateral end of the panel to form a second loop. The upper support portion includes an upper perimeter proximate a top of the panel and a lower perimeter opposite the upper perimeter, and the lower support portion includes a lower perimeter proximate a bottom of the panel and an upper perimeter opposite the lower perimeter of the lower support portion. The central body portion spans an area between the lower perimeter of the upper support portion and the upper perimeter of the lower support portion. At a lateral center line of the panel between the first and second lateral ends of the panel, and when the upper and lower support portions are pulled in opposite longitudinal directions at the lateral center line of the panel, such that the panel is taut in the longitudinal direction of the panel at the lateral center line, the upper perimeter of the upper support portion is a first distance from the lower perimeter of the upper support portion, the lower perimeter of the lower support portion is a second distance from the upper perimeter of the lower support portion, and the lower perimeter of the upper support portion is a third distance from the upper perimeter of the lower support portion. The sum of the first and second distances is greater than the third distance.

According to a second aspect of the disclosure, a tree saddle includes a panel for cradling a user. The panel extends from a first lateral end to a second lateral end opposite the first lateral end and includes an upper support portion, a lower support portion, and a central body portion that is coupled to and extends between the upper and lower support portions. A first connector portion extends from the upper support portion to the lower support portion at the first lateral end of the panel to form a first loop. A second connector portion extends from the upper support portion to the lower support portion at the second lateral end of the panel to form a second loop. The upper support portion includes an upper perimeter proximate a top of the panel and a lower perimeter opposite the upper perimeter, and the lower support portion includes a lower perimeter proximate a bottom of the panel and an upper perimeter opposite the lower perimeter of the lower support portion. The central body portion spans an area between the lower perimeter of the upper support portion and the upper perimeter of the lower support portion. At a lateral center line of the panel between the first and second lateral ends of the panel, and when the upper and lower support portions are pulled in opposite longitudinal directions at the lateral center line of the panel, such that the panel is taut in the longitudinal direction of the panel at the lateral center line, the upper perimeter of the upper support portion is a first distance from the lower perimeter of the upper support portion, the lower perimeter of the lower support portion is a second distance from the upper perimeter of the lower support portion, and the lower perimeter of the upper support portion is a third distance from the upper perimeter of the lower support portion. A ratio of the third distance relative to the first distance is less than or equal to a 2 to 1 ratio.

According to a third aspect of the disclosure, a tree saddle includes panel for cradling a user. The panel extends from a first lateral end to a second lateral end opposite the first lateral end and includes an upper support portion, a lower support portion, and a central body portion that is coupled to and extends between the upper and lower support portions. A first connector portion extends from the upper support portion to the lower support portion at the first lateral end of the panel to form a first loop. A second connector portion extends from the upper support portion to the lower support portion at the second lateral end of the panel to form a second loop. The upper support portion includes an upper perimeter proximate a top of the panel and a lower perimeter opposite the upper perimeter, and the lower support portion includes a lower perimeter proximate a bottom of the panel and an upper perimeter opposite the lower perimeter of the lower support portion. The central body portion spans an area between the lower perimeter of the upper support portion and the upper perimeter of the lower support portion. At a lateral center line of the panel between the first and second lateral ends of the panel, and when the upper and lower support portions are pulled in opposite longitudinal directions at the lateral center line of the panel, such that the panel is taut in the longitudinal direction of the panel at the lateral center line, the upper perimeter of the upper support portion is a first distance from the lower perimeter of the upper support portion, the lower perimeter of the lower support portion is a second distance from the upper perimeter of the lower support portion, and the lower perimeter of the upper support portion is a third distance from the upper perimeter of the lower support portion. The upper and lower support portions of the panel and the first and second connecting portions each are comprised of a common continuous length of nylon webbing that defines the upper and lower perimeters of the upper and lower support portions of the panel at the lateral center line of the panel. The first distance is about 4 inches, the second distance is about 4 inches, and the third distance is greater than 4 inches and less than 7 inches.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a tree saddle;

FIG. 2 is an elevational view of the tree saddle, illustrating a rear face of a panel of the tree saddle that includes an upper support portion, a lower support portion, and a central body portion;

FIG. 3 is an elevational view of the tree saddle, illustrating a front face of the panel of the tree saddle;

FIG. 4 is an elevational view of a portion of the tree saddle, illustrating a connector portion of the tree saddle; and

FIG. 5 is an elevational view of a patch of material that includes first and second V-shaped notches.

### DETAILED DESCRIPTION OF THE PREFERRED EMBODIMENTS

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, unless stated otherwise, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

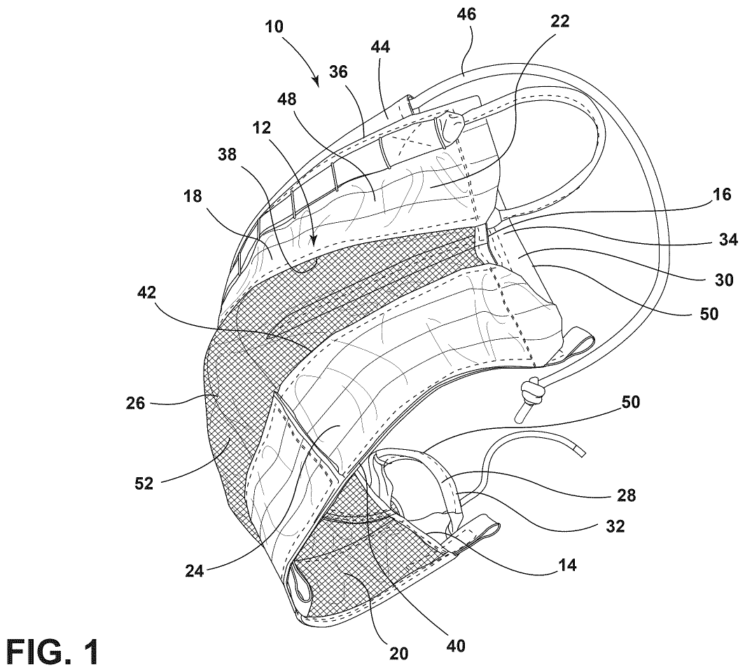

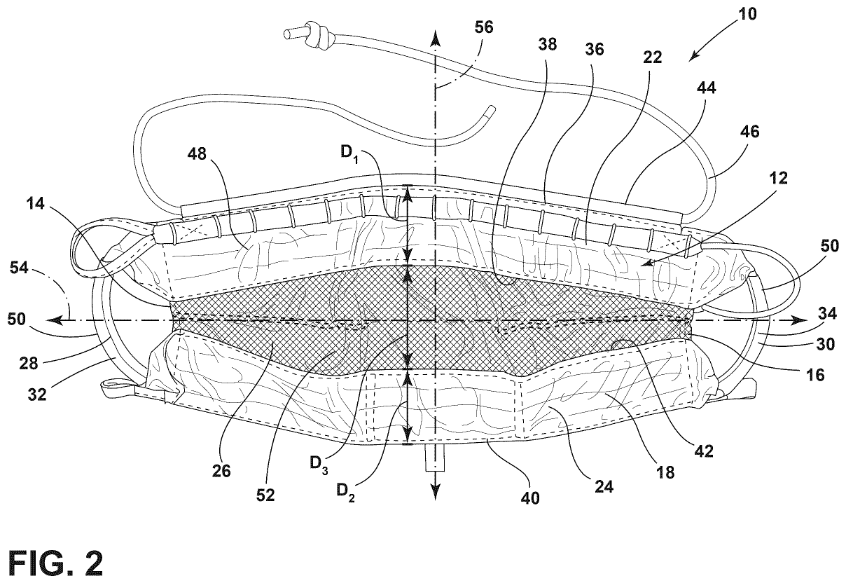

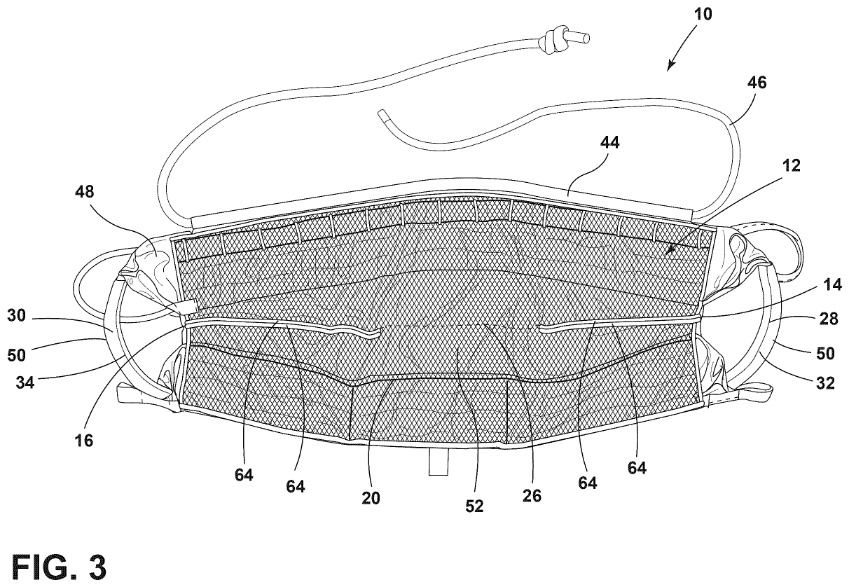

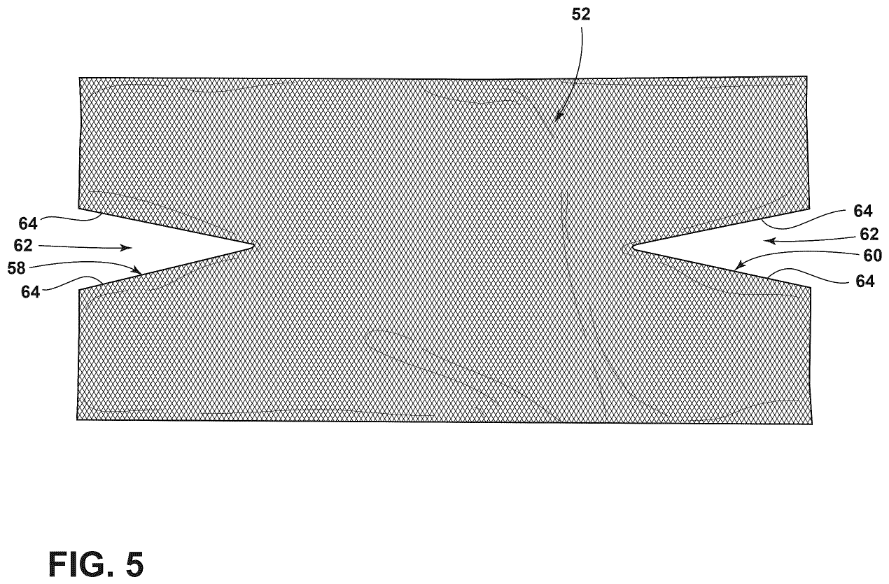

Referring now to FIGS. 1-5, a tree saddle 10 is disclosed. The tree saddle 10 is configured to cradle the lower back, rear thigh, and/or buttocks of a user. The tree saddle 10 includes a panel 12 that is configured to cradle the user. The panel 12 extends from a first lateral end 14 to a second lateral end 16 opposite the first lateral end 14. The panel 12 includes a rear face 18 (FIG. 2) that faces away from the user occupying the tree saddle 10 and a front face 20 (FIG. 3) opposite the rear face 18 that is configured to face and contact the user occupying the tree saddle 10. The panel 12 includes an upper support portion 22, a lower support portion 24, and a central body portion 26. The central body portion 26 is coupled to and extends between the upper and lower support portions 22, 24. The tree saddle 10 further includes a first connector portion 28 and a second connector portion 30. The first connector portion 28 extends from the upper support portion 22 to the lower support portion 24 at the first lateral end 14 of the panel 12 to form a first loop 32. The second connector portion 30 extends from the upper support portion 22 to the lower support portion 24 at the second lateral end 16 of the panel 12 to form a second loop 34. These first and second loops 32, 34 can be referred to as a first bridge loop and a second bridge loop. The tree saddle 10 may include various other loops, sleeves, and belts and/or ropes. It is contemplated that additional support ropes/belts may be utilized beyond what is illustrated in the figures, in various implementations.

Referring now to FIG. 2, the upper support portion 22 includes an upper perimeter 36 that is proximate a top of the panel 12 and a lower perimeter 38 opposite the upper perimeter 36. Further, the lower support portion 24 includes a lower perimeter 40 proximate a bottom of the panel 12 and an upper perimeter 42 that is opposite the lower perimeter 40 of the lower support portion 24. In some implementations, a sleeve 44 for accommodating a rope 46 extending therethrough may be sewn to the upper support portion 22 of the panel 12. The sleeve 44 may extend away from the lower perimeter 38 of the upper support portion 22 beyond the upper perimeter 36 of the upper support portion 22.

In various implementations, the upper and lower support portions 22, 24 of the panel 12 are formed of a nylon webbing 48. In some embodiments, the upper and lower support portions 22, 24 of the panel 12 and the first and second connector portions 28, 30 of the tree saddle 10 are each comprised of a common continuous length of the nylon webbing 48. In the embodiment illustrated in FIG. 2, a common continuous length of 4-inch-wide nylon webbing 48 is utilized in the upper and lower support portions 22, 24 of the panel 12 and the first and second connector portions 28, 30 of the tree saddle 10. In various implementations, the common continuous length of nylon webbing 48 defines the upper and lower perimeters 36, 38 of the upper support portion 22 and the upper and lower perimeters 40, 42 of the lower support portion 24 of the panel 12. The portions of the nylon webbing 48 that form the first and second connector portions 28, 30 may be folded and wrapped in a sheath 50 that is sewn to the nylon webbing 48 to maintain the shape of the first and second connector portions 28, 30.

As illustrated in FIGS. 1-3, the central body portion 26 of the panel 12 spans an area between the lower perimeter 38 of the upper support portion 22 and the upper perimeter 42 of the lower support portion 24. In various embodiments, the central body portion 26 of the panel 12 comprises a patch of material 52 that is sewn to the upper and lower support portions 22, 24. A variety of types of materials are contemplated. In the embodiment illustrated in FIGS. 1-3, the central body portion 26 of the panel 12 comprises a breathable mesh material.

Referring now to FIG. 2, the tree saddle 10 is illustrated and overlaid with a first line 54 that represents lateral directions in reference to the tree saddle 10 and a second line 56 that extends longitudinally and represents the lateral center line of the panel 12 of the tree saddle 10. When the upper and lower support portions 22, 24 of the panel 12 are pulled in opposite longitudinal directions at the lateral center line of the panel 12, such that the panel 12 is taut in the longitudinal direction of the panel 12 at the lateral center line, the upper perimeter 36 of the upper support portion 22 is a first distance D₁ from the lower perimeter 38 of the upper support portion 22 at the lateral center line of the panel 12. Further, in this configuration of the tree saddle 10 at the lateral center line of the panel 12, the lower perimeter 40 of the lower support portion 24 is a second distance D₂ from the upper perimeter 42 of the lower support portion 24, and the lower perimeter 38 of the upper support portion 22 is a third distance D₃ from the upper perimeter 42 of the lower support portion 24.

In some implementations, the first distance D₁ is substantially equal to and/or equal to the second distance D₂. In some implementations, the sum of the first and second distances D₁, D₂ is greater than the third distance D₃. In an exemplary implementation, a ratio of the third distance D₃ relative to the first distance D₁ is less than or equal to a 2 to 1 ratio. Further, in some implementations, a ratio of the third distance D₃ relative to the second distance D₂ is less than or equal to a 2 to 1 ratio. In various embodiments, a ratio of the third distance D₃ relative to the first distance D₁ is less than or equal to a 3 to 2 ratio. In some implementations, a ratio of the third distance D₃ relative to the second distance D₂ is less than or equal to a 3 to 2 ratio. In some embodiments of the tree saddle 10, the first distance D₁ is about 4 inches, the second distance D₂ is about 4 inches, and the third distance D₃ is greater than 4 inches and less than 7 inches. In an exemplary embodiment of the tree saddle 10, the first distance D₁ is about 4 inches, the second distance D₂ is about 4 inches, and the third distance D₃ is about 5.5 inches.

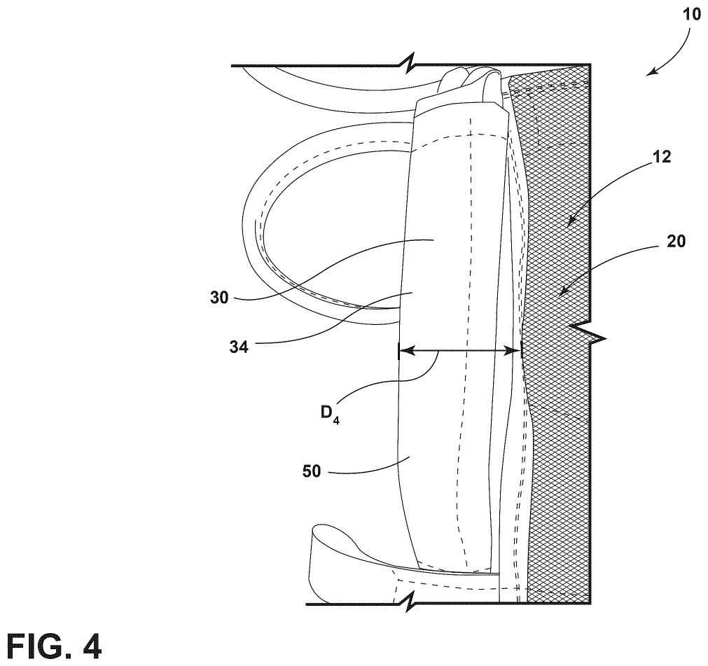

Referring now to FIGS. 2 and 4, at the laterally-outboard-most portion of the first and/or second connector portions 28, 30 of the tree saddle 10 (using FIG. 2 as a reference point of view for laterally-outboard-most), the maximum thickness of the first and/or second connector 28, 30 is a fourth distance D₄. In some embodiments, a ratio of the fourth distance D₄ relative to the third distance D₃ is less than or equal to an 8 to 1 ratio. In some embodiments, a ratio of the fourth distance D₄ relative to the third distance D₃ is less than or equal to a 6 to 1 ratio. In some embodiments, the fourth distance D₄ is between about 0.8 inches and 1.5 inches. In an exemplary embodiment, the fourth distance D₄ is about 1 inch.

Referring now to FIGS. 1-3 and 5, in some embodiments, the patch of material 52 that at least partially forms the central body portion 26 can include first and second notches 58, 60 that extend laterally inboard in narrowing fashion from the first and second lateral ends 14, 16 of the panel 12 of the tree saddle 10, respectively. The patch of material 52 that forms the central body portion 26 of the panel 12 is shown in isolation in FIG. 2. As shown in FIG. 2, the patch of material 52 includes the first and second V-shaped notches 58, 60 that each form gaps 62, respectively. In some embodiments, the patch of material 52 is sewn into the panel 12 of the tree saddle 10 in such a way that opposing edges 64 of the patch of material 52 that form the first notch 58 are positioned adjacent to each other to generally eliminate a gap 62 formed by the first notch 58, and the opposing edges 64 of the patch of material 52 that form the second notch 60 are positioned adjacent to each other to generally eliminate a gap 62 formed by the second notch 60. Including the first and second notches 58, 60 in the patch of material 52 and sewing the edges 64 of the first and second notches 58, 60 together, respectively, allows for the distance between the upper perimeter 42 of the lower support portion 24 and the lower perimeter 40 of the upper support portion 22 to be greater at the lateral center line of the panel 12 than at the first and second lateral ends 14, 16 of the panel 12, as illustrated in FIG. 1. It is contemplated that the patch of material 52 that forms the central body portion 26 of the panel 12 may have a variety of shapes, in various embodiments.

The tree saddle 10 of the present disclosure may provide a variety of advantages. First, the longitudinal size of the upper and lower support portions 22, 24 relative to the longitudinal size of the central body portion 26 of the panel 12 may provide additional support and comfort to a user of the tree saddle 10 while the user is suspended within the tree saddle 10. Second, utilizing the patch of material 52 with the first and second notches 58, 60 at the opposite lateral ends of the patch of material 52 allows for the upper and lower support portions 22, 24 to be sewn to the central body portion 26 of the panel 12 effectively with minimal excess fabric utilized in the central body portion 26 of the panel 12.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A tree saddle, comprising:
a panel for cradling a user, the panel extending from a first lateral end to a second lateral end opposite the first lateral end, comprising:
an upper support portion;
a lower support portion; and
a central body portion that is coupled to and extends between the upper and lower support portions;
a first connector portion that extends from the upper support portion to the lower support portion at the first lateral end of the panel to form a first loop; and
a second connector portion that extends from the upper support portion to the lower support portion at the second lateral end of the panel to form a second loop,
wherein the upper support portion includes an upper perimeter proximate a top of the panel and a lower perimeter opposite the upper perimeter, and the lower support portion includes a lower perimeter proximate a bottom of the panel and an upper perimeter opposite the lower perimeter of the lower support portion,
wherein the central body portion spans an area between the lower perimeter of the upper support portion and the upper perimeter of the lower support portion,
wherein, at a lateral center line of the panel between the first and second lateral ends of the panel and when the upper and lower support portions are pulled in opposite longitudinal directions at the lateral center line of the panel, such that the panel is taut in the longitudinal direction of the panel at the lateral center line, the upper perimeter of the upper support portion is a first distance from the lower perimeter of the upper support portion, the lower perimeter of the lower support portion is a second distance from the upper perimeter of the lower support portion, and the lower perimeter of the upper support portion is a third distance from the upper perimeter of the lower support portion, and
wherein the sum of the first and second distances is greater than the third distance.

2. The tree saddle of claim 1, wherein the first distance is substantially equal to the second distance.

3. The tree saddle of claim 2, wherein the first distance is about 4 inches and the second distance is about 4 inches.

4. The tree saddle of claim 3, wherein the upper and lower support portions of the panel and the first and second connecting portions each are comprised of a common continuous length of nylon webbing.

5. The tree saddle of claim 4, further comprising a sleeve sewn to the upper support portion and extending away from the lower perimeter of the upper support portion beyond the upper perimeter of the upper support portion.

6. The tree saddle of claim 4, wherein the third distance is about 5.5 inches.

7. The tree saddle of claim 1, wherein a ratio of the third distance relative to the first distance is less than or equal to a 2 to 1 ratio.

8. The tree saddle of claim 1, wherein a ratio of the third distance relative to the second distance is less than or equal to a 2 to 1 ratio.

9. The tree saddle of claim 1, wherein a ratio of the third distance relative to the first distance is less than or equal to a 3 to 2 ratio.

10. The tree saddle of claim 1, wherein a ratio of the third distance relative to the second distance is less than or equal to a 3 to 2 ratio.

11. The tree saddle of claim 1, wherein the upper and lower support portions of the panel are formed of nylon webbing.

12. The tree saddle of claim 11, wherein the upper and lower support portions of the panel and the first and second connecting portions each are comprised of a common continuous length of nylon webbing.

13. The tree saddle of claim 1, wherein the body portion of the panel comprises a breathable mesh material.

14. A tree saddle, comprising:
a panel for cradling a user, the panel extending from a first lateral end to a second lateral end opposite the first lateral end, comprising:
an upper support portion;
a lower support portion; and
a central body portion that is coupled to and extends between the upper and lower support portions;
a first connector portion that extends from the upper support portion to the lower support portion at the first lateral end of the panel to form a first loop; and
a second connector portion that extends from the upper support portion to the lower support portion at the second lateral end of the panel to form a second loop,
wherein the upper support portion includes an upper perimeter proximate a top of the panel and a lower perimeter opposite the upper perimeter, and the lower support portion includes a lower perimeter proximate a bottom of the panel and an upper perimeter opposite the lower perimeter of the lower support portion,
wherein the central body portion spans an area between the lower perimeter of the upper support portion and the upper perimeter of the lower support portion,
wherein, at a lateral center line of the panel between the first and second lateral ends of the panel and when the upper and lower support portions are pulled in opposite longitudinal directions at the lateral center line of the panel, such that the panel is taut in the longitudinal direction of the panel at the lateral center line, the upper perimeter of the upper support portion is a first distance from the lower perimeter of the upper support portion, the lower perimeter of the lower support portion is a second distance from the upper perimeter of the lower support portion, and the lower perimeter of the upper support portion is a third distance from the upper perimeter of the lower support portion, and
wherein a ratio of the third distance relative to the first distance is less than or equal to a 2 to 1 ratio.

15. The tree saddle of claim 14, wherein the sum of the first and second distances is greater than the third distance.

16. The tree saddle of claim 14, wherein a ratio of the third distance relative to the second distance is less than or equal to a 3 to 2 ratio.

17. The tree saddle of claim 16, wherein the third distance is about 5.5 inches.

18. The tree saddle of claim 17, wherein the first distance is substantially equal to the second distance.

19. The tree saddle of claim 18, wherein the first distance is about 4 inches and the second distance is about 4 inches.

20. A tree saddle, comprising:
a panel for cradling a user, the panel extending from a first lateral end to a second lateral end opposite the first lateral end, comprising:
an upper support portion;
a lower support portion; and
a central body portion that is coupled to and extends between the upper and lower support portions;
a first connector portion that extends from the upper support portion to the lower support portion at the first lateral end of the panel to form a first loop; and
a second connector portion that extends from the upper support portion to the lower support portion at the second lateral end of the panel to form a second loop,
wherein the upper support portion includes an upper perimeter proximate a top of the panel and a lower perimeter opposite the upper perimeter, and the lower support portion includes a lower perimeter proximate a bottom of the panel and an upper perimeter opposite the lower perimeter of the lower support portion,
wherein the central body portion spans an area between the lower perimeter of the upper support portion and the upper perimeter of the lower support portion,
wherein, at a lateral center line of the panel between the first and second lateral ends of the panel and when the upper and lower support portions are pulled in opposite longitudinal directions at the lateral center line of the panel, such that the panel is taut in the longitudinal direction of the panel at the lateral center line, the upper perimeter of the upper support portion is a first distance from the lower perimeter of the upper support portion, the lower perimeter of the lower support portion is a second distance from the upper perimeter of the lower support portion, and the lower perimeter of the upper support portion is a third distance from the upper perimeter of the lower support portion,
wherein the upper and lower support portions of the panel and the first and second connecting portions each are comprised of a common continuous length of nylon webbing that defines the upper and lower perimeters of the upper and lower support portions of the panel at the lateral center line of the panel, and
wherein the first distance is about 4 inches, the second distance is about 4 inches, and the third distance is greater than 4 inches and less than 7 inches.
